(19) United States
(12) Patent Application Publication
(10) Pub. No.: US 2006/0085246 A1
(43) Pub. Date: Apr. 20, 2006

(54) Responsive promotion replenishment planning

(76) Inventor: Sheng Li, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/956,632

(22) Filed: Sep. 30, 2004

(51) Int. Cl. G07G 1/00

(52) U.S. Cl. 705/10

(57) ABSTRACT

Embodiments include a system for adjusting forecast demand data in light of actual sales of a product. The system and method may include forecasting demand for a time period then adjusting the demand forecast over that period of time based on sales feedback data. Forecasted demand may be distributed over the time period based on a distribution pattern. Demand may be adjusted if actual sales meet predetermined threshold levels or if actual sales deviate from a range of forecasted demand.

### BACKGROUND

1. Field of the Invention

The invention relates to supply chain management. Specifically, predicting future demand for a set of products.

2. Background

A supply chain is a network of retailers, distributors, transporters, warehouses, and suppliers that take part in the production, delivery and sale of a product or service. Supply chain management is the process of coordinating the movement of the products or services, information related to the products or services, and money among the constituent parts of a supply chain. Supply chain management also integrates and manages key processes along the supply chain. Supply chain management strategies often involve the use of software to project and fulfill demand and improve production levels.

Logistics is a subset of the activities involved in supply chain management. Logistics includes the planning, implementation and control of the movement and storage of goods, services or related information. Logistics aims to create an effective and efficient flow and storage of goods, services and related information from a source to the target location where the product or source is to be shipped to meet the demands of a customer.

The movement of goods and services through a supply chain often involves the shipment of the goods and services between the source location at which the product is produced or stored and the target location where the product is to be shipped to the wholesaler, vendor or retailer. The shipment of products involves a transport such as a truck, ship or airplane and involves the planning of the arrangement of the products to be shipped in the transport. The source location from which a set of products is shipped on a transport is selected based on the availability of the products at the source location.

Demand for a product at a target location may be either ‘turn’ demand or ‘promotion’ demand. Turn demand is related to typical daily levels of demand. Promotion demand is related to a promotion related to a target location. Promotions may be sales events at retail outlets or special pricing or similar incentives offered by a manufacturer to boost the sales of a product. During a promotion a larger demand for a product will be generated.

Supply chain management systems generate a demand forecast prior to shipping a product. However, actual demand may deviate from the forecast. This results in inefficient use of transports and inventory storage space because the forecast demand used to determine the size of shipments to send to a target location may be too large resulting in overstock or too small resulting in an out of stock scenario.

### SUMMARY

Embodiments include a system for adjusting forecasted demand data in light of actual sales of a product. The system and method may include forecasting demand for a time period then adjusting the demand forecast over that period of time based on sales feedback data. Forecasted demand may be distributed over the time period based on a distribution pattern. Initial demand orders are generated for the time period based on the forecasted demand. Demand and demand orders may be adjusted over the remainder of the time period if actual sales meet or exceed predetermined threshold levels or if actual sales deviate from a range of forecasted demand.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a flowchart of one embodiment of a process for generating a forecast of demand.

FIG. 2 is a flowchart of one embodiment of a process for adjusting a forecast of demand based on feedback data.

FIG. 3A is a diagram of one embodiment of a first arrival at distribution center (DC) date determination scheme.

FIG. 3B is a diagram of one embodiment of a promotion dates determination scheme.

FIG. 3C is a diagram of one embodiment of a demand pattern promotion scheme.

FIG. 4A is a diagram of one embodiment of a static promotion management system.

FIG. 4B is a diagram of one embodiment of dynamic promotion management system.

FIG. 4C is a diagram of one embodiment of a reactive promotion management system.

FIG. 5 is a diagram of one embodiment of a promotion management system in a network environment.

FIG. 6 is a diagram of one embodiment of a distributed promotion management system.

### DETAILED DESCRIPTION

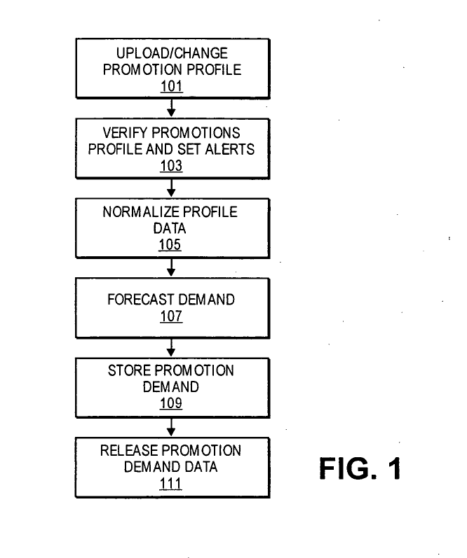

FIG. 1 is a flowchart of one embodiment of a process for generating a forecast of demand for a set of products over a defined time period. The demand forecasting system may be utilized to generate a forecast of demand for any type of product or set of products to facilitate shipment and storage of the products in a supply chain. For example, the demand forecasting system may be used to manage the delivery of products to a distribution center from a factory. In one embodiment, the demand forecasting system may be used utilized in the context of forecasting promotion demand for a set of products. Promotion products may be products associated with a planned sale or similar type of advertisement or promotion of the product. Promotion demand may include any type of sales event. In contrast, turn products may be products sold without a specialized promotion, advertisement campaign, coupon, sale or similar promotion. The demand forecasting system may be utilized with promotion or turn product demand. For sake of convenience promotion demand is used as an example. Turn product demand or other types of demand including short term demand and combinations thereof may be similarly handled.

In one embodiment, the forecasting system may utilize promotion profiles to track the characteristics of individual promotions. Promotion profiles may be associated with a product, set of products, specific target locations, manufacturers, businesses and similar elements and combinations thereof. As used herein a “target location” may be any shipping destination for a product including a distribution center, factory, warehouse, retail outlet, or similar location. Promotion profiles may include data such as promotion types, event types, distribution patterns, sales patterns and similar data. The promotion profile may be stored in a discrete data structure. The data structure may have an established format. For example, the data structure may be an XML file or similar type of file.

In one embodiment, the demand forecast process may be utilized in a promotion management system. The forecast process may be initiated by the input or reception of a promotion profile or similar data by the promotion management system (block 101). The promotion profile may be received by the promotion management system from a customer, vendor, manufacturer or similar entity involved in the supply chain. The promotion profile may be related to a product or set of products associated with a promotion. In one embodiment, the promotion profile may be uploaded into the forecast demand system from a remote location such as a store, distribution center, factory or similar location. In another embodiment, the promotion profile may be generated or input through a user interface.

In one embodiment, the promotion profile to be processed may be checked to determine the completeness and accuracy of the contents of the file (block 103). If the promotion profile lacks essential data or includes essential data that is inaccurate, an alert may be generated to flag the promotion profile to be reviewed by a system administrator or similar user. The entity that input or sent the profile may be notified of the error. The promotion profile may be checked to determine if each of a set of characteristics of the promotion has been included in the profile and within a valid range for its data type. The promotion profile may be checked to determine if the associated products have been identified, the promotion type specified, the distribution and sales patterns identified, the event type identified, promotion start and end dates and similar characteristics defined.

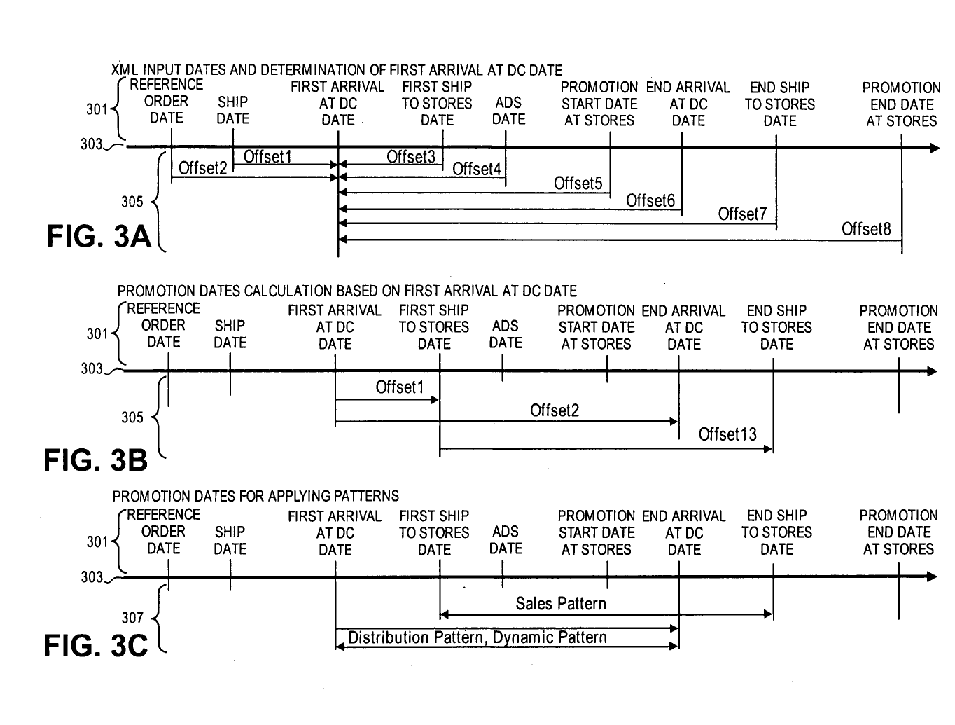

In one embodiment, the data in the promotion profile may be normalized for processing by the promotion management system (block 105). In one embodiment, the promotion profile may specify data that is not standard to each potential client utilizing the system. For example, different clients may designate different dates as the ‘start’ and ‘end’ dates for a promotion or period of sale for a product to be handled by the promotion management system. FIGS. 3A-3C are charts illustrating the key dates of an example promotion timeline. The entity (e.g., a manufacturer, retailer wholesaler, or similar entity) sending the promotion profile may utilize a myriad of dates in defining a promotion, period of sale or distribution. These critical dates may be defined differently by different entities but most will have the same relationships to one another and can be processed if the critical dates are normalized to a standard starting, end or midpoint. The promotion management system may identify each of these critical dates for a promotion by determining an ‘offset’ for the promotion profile. The offset may be determined by a look-up of the offset in a data structure tracking offsets for all entities using the system, by retrieving the data from other related promotion profiles or by similar methods. Crucial dates in a supply chain for planning a promotion or similar period of sale may include: reference order date, ship date, first arrival at distribution center (DC) data, first ship to stores date, advertisement date, promotion start date at stores, end delivery date for DC, end deliver date for stores, promotion end date at stores and similar dates. The promotion management system may normalize each of the incoming ‘start’ dates using an offset to a single ‘start’ standard. For example, all dates may be normalized to the first arrival at distribution center (DC) date (see FIG. 3A).

In one embodiment, after a start date has been determined and normalized, other key dates for the planning management process may be derived using a set of known offsets specific to the entity that is associated with the promotion profile, a set of standard or default offsets, promotion type specific offsets or similar offsets. For example, the promotion management system may determine a first ship to stores date, end delivery at DC date and end ship to stores date using known offsets for the entity associated with the promotion profile. A single entity may have multiple sets of offsets that represent different running times for different types of promotions or sales that may be utilized to derive the other critical dates. Each of these sets of offsets may be designated as an event type. For example, an entity may have a two week coupon event type and a weekend sale event type. Each event type is associated with a sale or promotion having a different running time that is represented in different offset sets.

In one embodiment, promotion profiles may also be associated with or include sales and distribution patterns. Sales and distribution patterns may represent expected or historical levels of demand in terms of sales and requisite distribution levels over a period of time. For example, the period of time may be a promotion where sales on the first day of the promotion start date at stores accounts for fifty percent of the total sales of the promoted products and the remaining days account for ten percent each. These patterns may have their start and end dates identified differently by different customers or by different event types. These patterns may be normalized by the promotion management system. In one embodiment, the promotion management system may apply sales patterns from the first ship to stores date until the end ship to stores date and distribution patterns from the first arrival at DC date until the end arrival at DC date (see FIG. 3C). In another embodiment, these and other patterns may be applied to any date range. The applications of sales and distribution patterns may be specific to an entity target location or event type. Default or generic patterns may also be utilized.

In one embodiment, the promotion manager may generate a forecast of demand for a desired time period (block 107). The forecast of demand may include the determination of expected sales and expected distribution demand. The forecast of demand distribution may be generated by applying sales and distribution patterns to a total demand value. The total demand may be distributed over the specified time period in accordance with the sales and distribution patterns. In one embodiment, the total demand may be input by a user of the promotion management system or may be specified by a customer or similarly supplied to the promotion management system. In another embodiment, the promotion management system may be part of a larger supply chain management system. The supply chain management system may include a forecasting module that generates a total demand based on historical, analogous and similar product distribution and sales data as well as entity and target sales and distribution models.

In one embodiment, the forecast of promotion demand and distribution data may be saved to a persistent storage layer or device (block 109). The data may be stored as part of a promotion profile or may be stored in a separate file or data structure. In one embodiment, the forecast of demand and distribution data may be released to the larger supply chain management system (block 111). The data release may include the initial shipment information for the first segment of the time period of the promotion. For example, if the forecast is for a promotion that lasts a week and the forecast distributed demand such that each day 100 units were to be shipped, then the promotion management may release the first day shipment demand of 100 units. The following day the next 100 unit demand order may be released. In another embodiment, the entire forecast or any subset of the forecast date may be released.

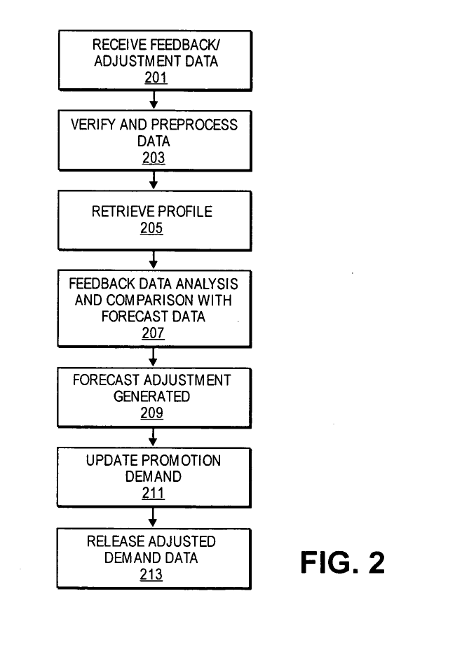

FIG. 2 is a flowchart of one embodiment of the process for adjusting and updating the forecast and demand based on feedback data (block 201). In one embodiment, feedback data may be in the form of sales data from stores, inventory data from distribution centers or similar demand data. The data may be associated with a particular promotion, customer, set of products or similar identification. In one embodiment, the promotion management system may process the incoming feedback data to verify the accuracy and completeness of the data (block 203). The processing may include separating turn demand data from promotion demand data.

In one embodiment, the promotion management system retrieves the promotion profile and stored forecast and demand data associated with the received feedback data (block 205). The associated profile and forecast data may be explicitly identified with the feedback data or may be determined based on the products, target locations, entities, promotions or similar indicators included in the feedback data. The retrieved profile and stored forecast data may be compared to the feedback data (block 207). The feedback data may be analyzed to determine to what degree it deviated from the forecasted demand or similarly compared to the forecast data.

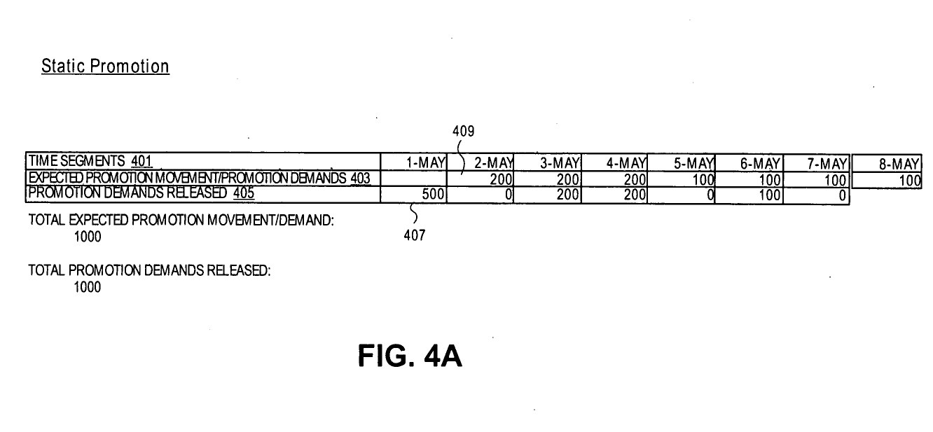

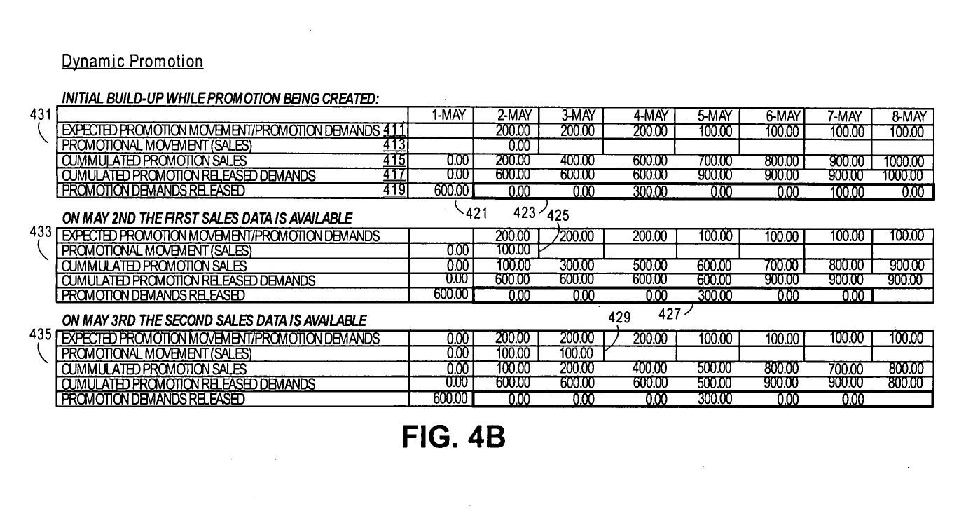

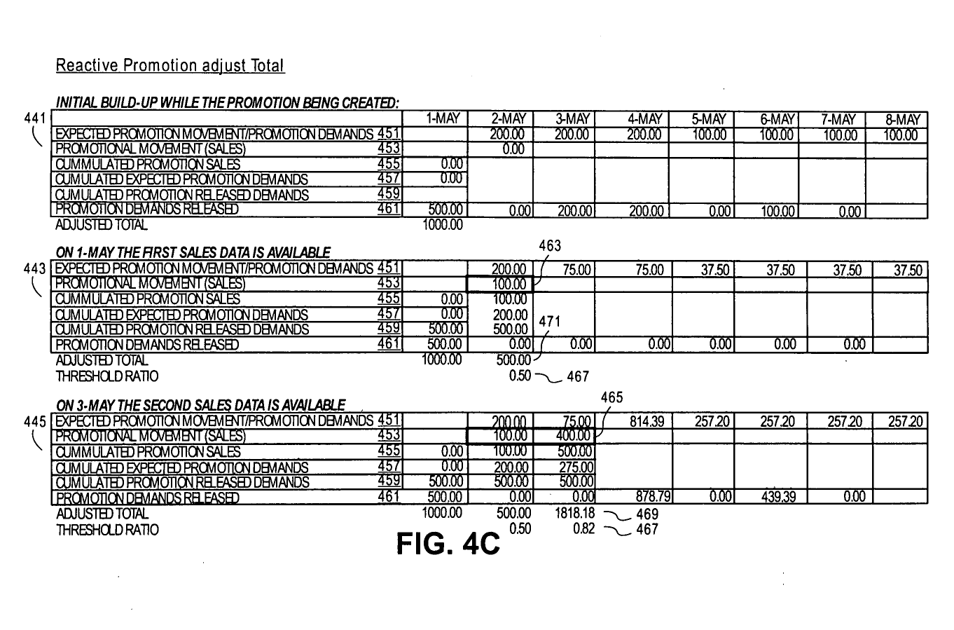

In one embodiment, the promotion management system may adjust the forecasted promotion demand and distribution data based on the feedback data and the comparison of that data with the previously forecast demand data (block 209). In one embodiment, the forecast data may be adjusted dependent on the promotion update type. Promotion update types may include a static promotion update type, dynamic promotion update type or reactive promotion update type. Each of the promotion update types are described in greater detail below in reference to example illustrations of each promotion update type in FIGS. 4A-4C.

In one embodiment, after the forecast data has been recalculated based on the promotion update type the new promotion demand quantities for each segment of the time period are updated and stored (block 211). The updated forecast data may be stored in the promotion profile, a separate file or similar data structure. The updated forecast quantities for the next time segment may be updated and released to the supply chain management system (block 213). In another embodiment, the entire set of updated forecast data or any subset of that data may be released.

FIG. 3A is a diagram of a one example embodiment of a first arrival at destination scheme. In this example, a set of critical dates 301 are charted on a time line 303. Critical dates may be any date related to the shipment of a product or set of products to a particular destination. In this example, the destination is a distribution center (DC). These critical dates may include reference order dates (date of first arrival of a shipment to DC), first ship to stores date (re-shipping product to store from DC), advertisement date (date ads are published related to promotion/product), promotion start date at store, end arrival at DC/stores or similar locations, end promotion date and similar dates. These dates may be related to one another by a set of offsets 305 from a standard or defining critical date 301. Offsets 305 and critical dates 301 may be stored in a promotion profile or similar data structure. Critical dates and offsets may vary for different entities and event types.

FIG. 3B is a diagram of one embodiment of a promotion date determination scheme. In this example, critical dates 301 may be determined by offsets 300 based on a known base data such as the first arrival at DC date. Receipt from an entity of a promotion profile containing an arrival at DC date may be used to determine other critical dates specific to that entity or promotion type. The offsets may be retrieved from the incoming profile, another profile from the same entity, a master file for the entity or similar source.

FIG. 3C is a diagram of one embodiment of an example application of a sales, distribution or promotion update pattern. Critical dates 301 may be used to define the start and end of patterns 307 on the promotion timeline. A pattern may be associated with any critical dates. In one embodiment, a sales pattern may be applied to a range of dates defined by a first ship to stores date and end ship to stores date. A distribution or promotion update type may be defined and end arrival at DC date.

FIGS. 4A-4C are representations of example embodiments of each of the promotion update types. FIG. 4A is a chart of an example static promotion. In a static promotion, promotion demand may be generated at the time the promotion profile is created. The demand may not be altered by the promotion management system. Manual changes may be allowed. The example chart includes a set of time segments 401, which in the example are days. In other embodiments, any time segment, such as hours, days, weeks, months or combinations thereof and similar time segments may be utilized.

In one embodiment, the static promotion may include an expected promotion movement or demand 403 over the time period and its constituent time segments 401. The expected promotion movement or demand 403 may be derived from historical data or may be a human estimate. In the example, the total expected promotion movement or demand is one thousand units. The movement or demand for these units is distributed over the course of a week. The demand released to the supply chain management 405 is also distributed over the course of the week, such that the release demand precedes the expected demand or movement. For example, the day before any expected demand, five hundred units 407 are designated for release to handle the expected demand of two hundred 409 for the following day.

FIG. 4B is a chart of an example embodiment of a dynamic promotion update system. A dynamic promotion update system may distribute forecast demand over a time period based on demand patterns (e.g., a sales pattern) and may distribute demand release over the time period based on when a set of threshold levels are met. A percentage of demand may be released when each threshold level is net. After each time feedback data, such as actual sales data or similar demand data, is received or on a periodic basis, a check may be made if actual demand (e.g., actual sales) deviates from the forecasted levels of demand. The forecasted demand release dates may be adjusted based on when the threshold levels are expected to be met based on a summation of cumulated actual demand and expected demand for each time segment in a time period. If actual demand has been lower than forecast then the threshold levels may be met at later dates and the demand release may be moved to a time segment corresponding to the later date. Similarly, if actual demand is greater than forecast then the demand release dates may be moved up.

The example chart of FIG. 4B depicts a dynamic promotion update over the time period of a week. The first instance of the example dynamic promotion 431 shows the expected promotion movement/demand 411, promotional (actual) sales 413, cumulated sales 415, cumulated released demand 417 and promotion released demand 419 for a week of the promotion. This instance 431 reflects the forecast at the time of the first creation of a forecast before any feedback data has been received. The expected total demand for the week may be derived from historical data or human estimation and the promotion demand 411 distribution over the week may be calculated from demand or sales pattern that may be derived from historical data or human estimation. A demand or sales pattern may be a set of percentages corresponding to each segment of the time period which indicate what part of the total demand for the time period is sold, shipped or similarly in demand for that segment of the time period.

This first instance 431 of the dynamic promotion does not include any feedback data 413. All the data after the first day is projected based on the expected demand. This first instance of the dynamic promotion indicates that six hundred units 421 were released on the first day of the promotion. The remainder 423 of the promotion demand release data is the projected release. The example dynamic promotion utilizes a threshold value to determine when additional units are released to the supply chain management system. In this example, thresholds of four hundred units and eight hundred units (values in the line 415) trigger additional demand release. In other embodiments, any number and value of threshold values may be used to dynamically control release of demand to a supply chain management system to minimize overstocking while providing adequate supply for a promotion. Similarly, meeting the threshold value may trigger the release of any amount of a product.

The example also shows a second instance 433 of the same dynamic promotion after a first day or similar time segment has passed and initial feedback data 425 has been received. In this example, the sales data for the first day is one hundred units 425. The feedback data is less than the expected promotion demand 411 causing the dynamic promotion to be updated by the promotion management system including the update of cumulated sales and projected promotion demand release data. The lower than expected actual sales cause the promotion management system to move the release dates for future demand release forward one day for the second release 427 and to remove the final release all together because the threshold values are not projected to be met until this later time. If the demand had been greater than expected then the release dates may have been moved forward if the thresholds are met at an earlier date.

The example includes a third instance 435 of the same dynamic promotion after a second day of feedback data has been received. The feedback data indicates that one hundred additional units 429 have been sold. In this example, the dates on which the threshold values are met are unaffected by the lower than expected sales on the second day. Lower or higher than predicted sales may cause the change of product release data 419 for any time period after the receipt of updated sales data.

FIG. 4C is a chart of one example of a reactive promotion update. The reactive promotion update system may utilize a demand pattern (e.g., sales pattern) similar to the dynamic promotion update system. The reactive promotion update system also may distribute demand release based on a demand distribution or release pattern. As feedback data (e.g., actual demand data) is received or on a periodic basis, a threshold ratio of actual demand to expected demand may be calculated to determine if actual demand differs from forecast demand. The total demand for a promotion may be altered in accordance with the threshold ratio and the new total demand minus the already released demand may be distributed over the remainder of the promotion time period according to the distribution pattern. In another embodiment, a total demand may be fixed and total actual demand may be subtracted from the fixed total and the difference distributed over the remainder of a time period based on the distribution pattern.

In the example representation of the reactive promotion update system, three instances of the reactive promotion are illustrated, each instance corresponding to a subsequent time of forecast generation. The first instance is a chart of the initially generated reactive promotion 441. The reactive promotion tracks expected promotion movement/demand 451, promotional (actual) sales 453, cumulated promotion sales 455, cumulated expected promotion demands 457, cumulated promotion released demands 459, and promotion demand released 461. The expected promotion movement/demand total and sales pattern 451 may be derived from historical data or human estimation and represent a percentage of a total demand that is expected to be sold or shipped for a time segment. In the example, the initial total expected demand is one thousand units distributed over the course of a week. An initial demand release may be determined based on the initial expected demand or similar criteria. In the example the initial demand release is half the expected total. Future scheduled demand release is determined based on the distribution pattern associated with the promotion.

The example includes a second instance updated for a subsequent time period where initial feedback data in the form of sales data has been received. The initial feedback data 463 indicates that half of the expected sales occurred. The promotion manager system calculates a threshold ratio 467 based on the ratio of the cumulated expected promotion demand 457 and cumulated promotion sales 455. The threshold ratio 467 may be used to calculate an adjusted demand total 471 and projected demand release 461 for the remainder of the time period. In the example, the adjusted total 471 is equal to the demand already released and no subsequent demand is scheduled to be released. Expected promotion movement/demand 451 is also adjusted for the remainder of the week based on the calculated threshold ratio value and sales pattern.

The cumulated promotion sales 455, cumulated expected promotion demand 457 and cumulated promotion release demand 459 may be updated for each time sequent with each new feedback data received. In some embodiments, the previously calculated release demand 459 and related data is not adjusted unless a set threshold ratio range is exceeded. Also, some embodiments may require that a designated number of time periods in a promotion elapse before an initial reactive promotion forecast is altered. Any number or type of time periods may be specified.

In the third instance 445 further feedback data is received in the form of sales data 465 indicating that an additional four hundred units have been sold. The threshold ratio is recalculated 467 and a new adjusted demand total 469 is determined. The unfulfilled demand is distributed over the remainder of the promotion period based on the distribution pattern. This process continues until the completion of the promotion time period.

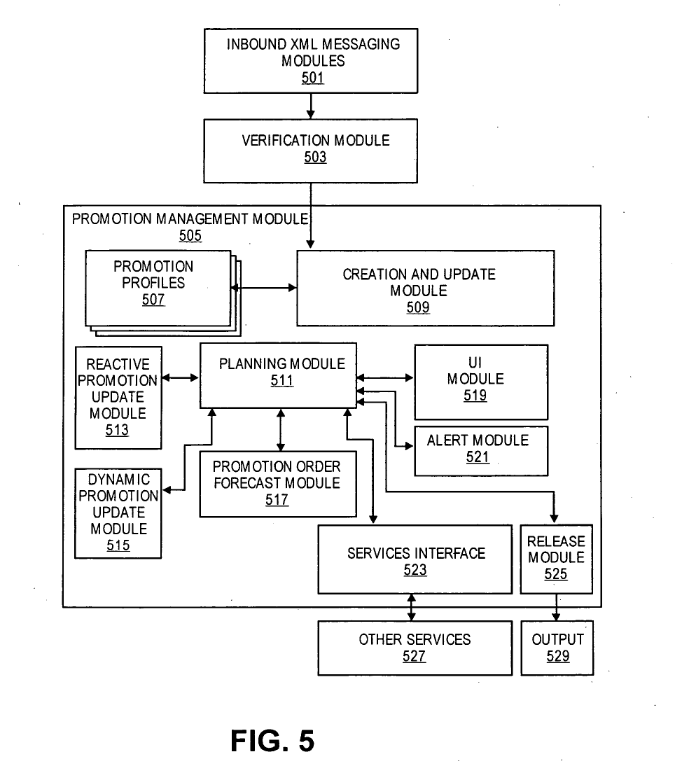

FIG. 5 is a diagram of one embodiment of a promotion management system. In one embodiment, the promotion management module 505 receives information from external sources such as entities, warehouses, stores and similar target locations via a messaging module 501. The messaging module may expect or utilize extensible markup language (XML) messages, electronic data interchange (EDI) or similar formats and protocols. The received messages may contain promotion profiles, feedback data or similar data. In one embodiment, the received data may be passed to a verification module 503 to check the accuracy and completeness of the data being received. The verification module 503 may check to determine if promotion profiles contain each of the constituent data fields or values, may check the origin of the data, may check to determine if the values fall within acceptable ranges or may make similar verification checks for incoming data. Errors may be logged and alerts generated during the verification process. In one embodiment, a sender of data may be requested to resend. In another embodiment, the system may not verify incoming data.

In one embodiment, the promotion management module 505 may include a creation and update module 509. The creation and update module 509 may create promotion profiles 507 and store them upon receiving promotion profile data from an external source. The creation and update module 509 may update the fields of a promotion profile with new data upon receiving feedback data. In another embodiment, the creation and update module 509 may receive promotion profile and feedback data through a user interface (UI) module 519. The UI module 519 may be a graphical user interface (GUI) or similar interface to allow a user to supply promotion related data to the promotion management module 505. Further, in one embodiment, the promotion related data is automatically updated periodically.

In one embodiment, the promotion management module 505 may include a planning module 511 to coordinate the processing of promotions. The planning module 511 may access and process promotion profiles on a periodic basis. The planning module 511 may access promotion profiles directly or through the creation and update module 509. Promotion profiles 507 may be stored local to the planning module or remotely. Planning module 511 may coordinate the application of a reactive promotion update module 513 for promotion profiles that are reactive promotions, dynamic promotion update module 515 for promotion profiles that are dynamic promotions, promotion order forecast module 517 to forecast demand based on historical data and similar data and factors and to coordinate the application of similar modules.

In one embodiment, the promotion management module 505 may include a services interface or similar interface to allow the planning module to access and utilize modules, services 527 and similar applications external to the promotion management module. In one embodiment, the promotion management module 505 may include an alert module 521 to generate alerts to a user when an error, verification failure or similar system event occurs. The promotion management module 505 may also include a release module 525 to output release data 529 to a supply chain management application or similar application. This output data 529 may be utilized to generate shipments from source locations to target locations to manage inventory levels during promotions and under similar circumstances.

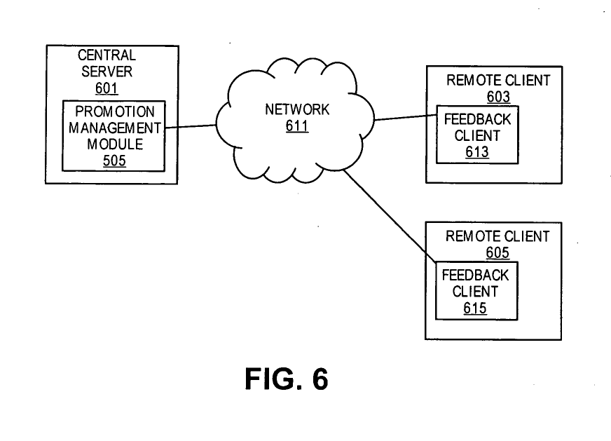

FIG. 6 is a diagram of one embodiment of a distributed promotion planning and management system. In one embodiment, the system may include a central server 601 running the core promotion management module 505. In another embodiment, the promotion management module may be components distributed over multiple machines. In a further embodiment, the promotion management system may be a local or stand alone machine.

In one embodiment, the promotion management module 505 may receive promotion data and feedback data from a remote client 603, 605 through feedback clients 613, 615 or similar applications via a network connection 611. The remote clients 603, 605 may be located or accessible by a customer, warehouse, source location, target location or similar location. Network 611 may be a local area network (LAN), wide area network (WAN), such as the Internet or similar communication system. In one embodiment, feedback client 613, 615 automatically establishes a virtual private network (VPN) with promotion management module 505 to provide periodic updates of promotional and turn sales data. The periodic updates may occur over any period (e.g., hourly, or daily). The frequency of the updates may also change depending on day of the week, for example, the update may be more or less frequent on weekends than during the week and may not occur at all (e.g., if the store is closed on a particular day).

In one embodiment, the demand forecasting system may be implemented in software and stored in a machine readable medium that can store or transmit data such as a fixed disk, physical disk, optical disk, compact disk (CDROM), digital versatile disk (DVD), floppy disk, magnetic disk, wireless device, infrared device and similar storage and transmission systems and technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
generating a first demand forecast for a set of products for a time period;
generating a first demand order based on the first demand forecast; and
adjusting the first demand forecast automatically to generate a second demand forecast for a remainder of the time period in response to received actual demand data.

2. The method of claim 1, further comprising:
triggering a second demand order if received actual demand data indicates that a threshold amount is reached.

3. The method of claim 1, further comprising:
calculating the second demand forecast based on a reactive update system.

4. The method of claim 1, further comprising:
utilizing the first demand forecast for an initial segment of the time period before the second demand forecast is generated or utilized.

5. The method of claim 1, further comprising:
distributing the first demand forecast over the first time period based on a distribution pattern.

6. The method of claim 5, further comprising:
distributing the second demand forecast over the remainder of the time period based on the distribution pattern.

7. The method of claim 1, further comprising:
retrieving a promotion profile to determine a first distribution pattern.

8. The method of claim 7, further comprising:
updating the promotion profile in response to an input; and
distributing the first demand forecast over the time period based on a second distribution pattern.

9. The method of claim 1, further comprising:
checking the received sales data to determine a variation from expected sales; and
generating a second shipment order based on the second demand forecast if the variation exceeds a defined range.

10. An apparatus comprising:
means for receiving promotion profile data;
means for generating a first demand forecast for a time period based on the promotion profile data;
means for receiving actual demand data; and
means for generating a second demand forecast for the time period utilizing the actual demand data to adjust the first demand forecast.

11. The apparatus of claim 10, further comprising:
means for storing a set of promotion profiles.

12. The apparatus of claim 10, further comprising:
means for verifying promotion profile data completeness.

13. A system comprising:
a promotion data module;
a demand forecasting module; and
one of a reactive update module and a dynamic update module to adjust demand forecasting for a time period based on received actual demand data.

14. The system of claim 13, further comprising:
an inbound messaging module to receive one of promotion profile data and actual demand data.

15. The system of claim 13, further comprising:
a verification module to check incoming promotion profile data.

16. A machine readable medium having a set of instructions stored therein which when executed cause a machine to perform a set of operations comprising:
generating a first demand forecast for a time period for a set of products;
generating a first demand order based on the first demand forecast; and
adjusting the first demand forecast automatically to generate a second demand forecast for a remainder of the time period in response to received actual demand data.

17. The machine readable medium of claim 16, having further instructions stored therein which when executed cause a machine to perform a set of operations further comprising:
triggering a second demand order if received actual demand data indicates that a threshold sales amount is reached.

18. The machine readable medium of claim 16, having further instructions stored therein which when executed cause a machine to perform a set of operations further comprising:
calculating the second demand forecast based on a reactive update system.

19. The machine readable medium of claim 16, having further instructions stored therein which when executed cause a machine to perform a set of operations further comprising:
utilizing the first demand forecast for an initial segment at the time period before the second demand forecast is generated or utilized.

20. The machine readable medium of claim 16, having further instructions stored therein which when executed cause a machine to perform a set of operations further comprising:
distributing the first demand forecast over the time based on a distribution pattern.

21. The machine readable medium of claim 16, having further instructions stored therein which when executed cause a machine to perform a set of operations further comprising:
distributing the second demand forecast over the remainder of the time period based on the distribution pattern.

22. The machine readable medium of claim 16, having further instructions stored therein which when executed cause a machine to perform a set of operations further comprising:
retrieving a promotion profile to determine a first distribution pattern.

23. The machine readable medium of claim 16, having further instructions stored therein which when executed cause a machine to perform a set of operations further comprising:
updating the promotion profile in response to an input; and
distributing the first demand forecast over the time period based on a second distribution pattern.

24. The machine readable medium of claim 16, having further instructions stored therein which when executed cause a machine to perform a set of operations further comprising:
checking the received actual demand data to determine a variation from expected demand; and
generating a second demand order based on the second demand forecast if the variation exceeds a defined range.
